(19) United States
(12) Patent Application Publication
(10) Pub. No.: US 2024/0257474 A1
(43) Pub. Date: Aug. 1, 2024

(54) SYSTEMS AND METHODS FOR SELECTIVELY DISPLAYING AR CONTENT

(71) Applicant: Shopify Inc., Ottawa (CA)

(72) Inventors: Russ MASCHMEYER, Berkeley, CA (US); Eric Andrew FLORENZANO, San Francisco, CA (US); Brennan LETKEMAN, Calgary (CA); Diego Macario BELLO, Montreal (CA); Daniel BEAUCHAMP, Toronto (CA)

(73) Assignee: Shopify Inc., Ottawa (CA)

(21) Appl. No.: 18/315,831

(22) Filed: May 11, 2023

Related U.S. Application Data
(60) Provisional application No. 63/482,198, filed on Jan. 30, 2023.

(51) Int. Cl. G06T 19/00; G01S 17/89; G06F 21/31; G06V 10/44

(52) U.S. Cl. CPC G06T 19/006; G01S 17/89; G06F 21/31; G06V 10/44; G06F 2221/2141; G06V 2201/07

(57) ABSTRACT

A computer-implemented is disclosed. The method includes: obtaining identifying information for an object, the object being in a field of view of an AR device, wherein the identifying information comprises implicit signals representing contextual data associated with the object; determining that the object is associated with a first object record based on comparing the identifying information with stored identifiers associated with the first object record; and responsive to the determination that the object is associated with the first object record, presenting, via the AR device, AR content that is specific to the first object record.

### CROSS-REFERENCE TO RELATED APPLICATION

The present application claims the benefit of priority to U.S. Provisional Patent Application No. 63/482,198 filed on Jan. 30, 2023, the contents of which are incorporated herein by reference.

### TECHNICAL FIELD

The present disclosure relates to augmented reality and, in particular, to systems and methods for selectively displaying AR content associated with real objects.

### BACKGROUND

Augmented reality systems enable computer-generated, virtual information to be displayed as overlays on a view of a real-world environment and its objects. AR content may be used to provide supplementary information about real objects that are in a user's field of view.

### BRIEF DESCRIPTION OF THE DRAWINGS

Implementations will be described, by way of example only, with reference to the accompanying figures wherein:

FIG. 1 illustrates an example system for providing augmented reality scenes;

FIG. 2 is a block diagram of an e-commerce platform that is configured for implementing example implementations of the AR engine of FIG. 1;

FIG. 3 shows a real-world view of an example analogue camera;

FIG. 4 shows an augmented view of the example analogue camera of FIG. 3 in AR;

FIG. 5 shows, in flowchart form, another example method for selectively displaying AR content associated with real objects;

FIG. 6 shows, in flowchart form, another example method for selectively displaying AR content associated with real objects;

FIG. 7 shows, in flowchart form, another example method for selectively displaying AR content associated with real objects;

FIG. 8A is a high-level schematic diagram of an example computing device;

FIG. 8B shows a simplified organization of software components stored in a memory of the computing device of FIG. 8A;

FIG. 9 is a block diagram of an e-commerce platform, in accordance with an example implementation; and

FIG. 10 is an example of a home page of an administrator, in accordance with an example implementation.

Like reference numerals are used in the drawings to denote like elements and features.

### DETAILED DESCRIPTION OF IMPLEMENTATIONS

In an aspect, the present application discloses a computer-implemented method. The method includes: obtaining identifying information for an object, the object being in a field of view of an AR device, wherein the identifying information comprises implicit signals representing contextual data associated with the object; determining that the object is associated with a first object record based on comparing the identifying information with stored identifiers associated with the first object record; and responsive to the determination that the object is associated with the first object record, presenting, via the AR device, AR content that is specific to the first object record.

In some implementations, the object may be of a first class of objects and determining that the object is associated with the first object record may include distinguishing the object from at least one other object of the same class based on the implicit signals.

In some implementations, obtaining the identifying information for the object may include performing object detection based on parsing a video depicting the object using an object detection model.

In some implementations, obtaining the identifying information for the object may include performing image analysis on frames of the video.

In some implementations, the identifying information for the object may include at least one of a barcode, a QR code, an NFC tag, or a serial number.

In some implementations, obtaining the identifying information for the object may include obtaining sensor output of at least one sensor associated with the AR device.

In some implementations, the at least one sensor may comprise at least one of GPS sensor, LIDAR scanner, or image sensors.

In some implementations, the identifying information for the object may include at least one of: geolocation of a user associated with the AR device at a time of detecting the object; visual features of a vicinity of the object; or LIDAR data indicating a specific location associated with the object.

In some implementations, the method may further include: obtaining a user identifier associated with the AR device; and verifying that a user associated with the user identifier is permitted to access the AR content, and the AR content presented via the AR device may be specific to the user associated with the user identifier.

In some implementations, the stored identifiers associated with the first object record may include at least one of: geolocation of previous users of an object associated with the first object record; identifiers of objects located in a vicinity of the object associated with the first object record; or an indication of an indoor location associated with the object associated with the first object record.

In some implementations, the AR content may include graphical representation of supplementary information associated with the object.

In another aspect, the present application discloses a computing system. The computing system includes a processor and a memory coupled to the processor. The memory stores computer-executable instructions that, when executed by the processor, configure the processor to: obtain identifying information for an object, the object being in a field of view of an AR device, wherein the identifying information comprises implicit signals representing contextual data associated with the object; determine that the object is associated with a first object record based on comparing the identifying information with stored identifiers associated with the first object record; and responsive to the determination that the object is associated with the first object record, present, via the AR device, AR content that is specific to the first object record.

In another aspect, the present application discloses a non-transitory, processor-readable medium storing processor-executable instructions that, when executed by a processor, are to cause the processor to: obtain identifying information for an object, the object being in a field of view of an AR device, wherein the identifying information comprises implicit signals representing contextual data associated with the object; determine that the object is associated with a first object record based on comparing the identifying information with stored identifiers associated with the first object record; and responsive to the determination that the object is associated with the first object record, present, via the AR device, AR content that is specific to the first object record.

Other example implementations of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “product data” refers generally to data associated with products that are offered for sale on an e-commerce platform. The product data for a product may include, without limitation, product specification, product category, manufacturer information, pricing details, stock availability, inventory location(s), expected delivery time, shipping rates, and tax and tariff information. While some product data may include static information (e.g., manufacturer name, product dimensions, etc.), other product data may be modified by a merchant on the e-commerce platform. For example, the offer price of a product may be varied by the merchant at any time. In particular, the merchant may set the product's offer price to a specific value and update said offer price as desired. Once an order is placed for the product at a certain price by a customer, the merchant commits to pricing; that is, the product price may not be changed for the placed order. Product data that a merchant may control (e.g., change, update, etc.) will be referred to as variable product data. More specifically, variable product data refers to product data that may be changed automatically or at the discretion of the merchant offering the product.

In the present application, the term “e-commerce platform” refers broadly to a computerized system (or service, platform, etc.) that facilitates commercial transactions, namely buying and selling activities over a computer network (e.g., Internet). An e-commerce platform may, for example, be a free-standing online store, a social network, a social media platform, and the like. Customers can initiate transactions, and any associated payment requests, via an e-commerce platform, and the e-commerce platform may be equipped with transaction/payment processing components or delegate such processing activities to one or more third-party services. An e-commerce platform may be extended by connecting one or more additional sales channels representing platforms where products can be sold. In particular, the sales channels may themselves be e-commerce platforms, such as Facebook Shops™, Amazon™, etc.

In the present application, the term “object instance” refers to a specific real object of an object class as distinguishable from at least one other real object of the same object class.

### Methods for Selectively Displaying AR Content

Real objects are generally associated with unique identifying information. In particular, a specific instance of a real object may be uniquely identified by certain information associated with that object instance. Whether the identifying information is explicit (e.g., QR code, serial number) or implicit (e.g., contextual data relating to a specific item), real objects may be associated with data that facilitates unique identification. An example class of identifying information for an object is ownership, e.g., identity of the owner(s) of the object. Users may want to be presented with customized AR content for objects that they own and/or have permission to access. For example, users may wish to access usage data for specific instances of objects (e.g., electronic device, musical instrument, appliance, house plant, etc.) that they personally own and have previously used.

Indeed, identifying information of objects may be employed for discriminately presenting AR content to individual users. In scenarios where a user encounters, in AR, multiple physical objects that are visually similar to one that they own (e.g., same or similar cars in a parking lot), it can be overwhelming and lead to poor user experience for the user to be overloaded with AR visuals for each such object. It is desirable for AR systems to leverage the uniqueness of instances of real objects in order to provide relevant AR content that is specific to each object instance.

The present invention encompasses a system for identifying specific instances of real objects and displaying relevant information in AR for the identified object instances. The proposed system is designed to leverage object detection and unique identifier matching in order to generate suitable AR content for displaying in association with specific object instances.

Mass-produced objects of the same class generally look the same. Using contextual data, it is possible to gain a level of confidence that a particular generic or mass-produced object is likely an instance of that class of objects as may be associated with a specific person. The object instance is then assumed to be associated with (e.g., belongs to, is in the home of, etc.) the person, so that AR content associated with that specific object instance can be provided to that person.

The system is configured to perform object detection based on image data obtained via an AR device. Specifically, the system may locate instances of a particular object in a user's field of view by parsing an image/video feed of the user's AR device (or other camera system). An object detection model, such as one that is trained on a large dataset of product images, may be employed for identifying objects and object instances. In some implementations, the detected real object may be a “stand-in” object (e.g., a wooden block) that represents a different object in AR (e.g., a point-of-sale).

Real objects may be associated with data (e.g., object metadata) that includes unique object instance identifying information. The system may store and/or have access to (e.g., stored remotely, for example, in the cloud) records of identifying information, such as object metadata, associated with various object instances. Object identifying data may include information classifiable as explicit or implicit. Explicit identifying information may include, for example, QR code, NFC (or other short-range communication protocol) tag, and the like. Explicit signals comprise information that associates a specific object instance with a defined piece of identifying data.

On the other hand, implicit identifying information may comprise contextual data associated with an object instance. In particular, implicit identifying information may include information relating to an environment of the object instance. Such information may include, without limitation: geolocation of the object instance and its previous/permitted user(s); description of a surrounding of the object instance (e.g., background scene, nearby objects, etc.); LIDAR information (e.g., specific room associated with the object instance).

Implicit identifying information may be obtained via various sources of environmental data. In some implementations, implicit identifying information may be derived based on sensor output of sensors, such as LIDAR scanner, GPS, indoor positioning system (IPS), image sensors, and the like. The system may store or have access to data records that include explicit and/or implicit identifying information for known object instances. Each data record of an object instance may be associated with user ID information. For example, each object instance may be associated with one or more users (e.g., owner(s), permitted user(s)) using, for example, unique user IDs.

Once an instance of an object is detected in an image/video feed, the system may attempt to identify a match between the identifying information for the detected object instance and identifying information for known object instances. In particular, the system may compare (1) explicit and implicit identifying information for the detected object with (2) unique identifiers of known instances of the object/object class, e.g., identifying information stored in data records (“object records”) associated with known object instances. The identifying information for the detected object instance may include, for example: parsed QR/bar code based on video feed; geolocation of the user at time of object instance detection; visual features (e.g., background, nearby objects, etc.) as depicted in images of vicinity of the detected object instance; LIDAR information; and sensor output of other sensors to which the system has access.

By identifying a match, a detected object instance may be confirmed to be a known object instance and associated with a specific user, such as the object's owner. In response to identifying a match, the system may cause to be displayed AR content related to the specific object instance for those users that are associated with the object instance. For example, if a user viewing the object instance (using an AR device) is an owner of the object instance, the user may be presented with the instance-specific AR content. A user ID associated with the AR device may be cross-referenced with “permitted users” data for the specific object instance. The AR content may comprise virtual overlay content (e.g., images, text, etc.) on a real-world view of the user's surrounding environment provided via an AR-enabled device. For example, the AR content may include relevant usage information associated with a detected object instance. The AR content need not be visual and may, in some scenarios, include audio data. In some implementations, the AR content may take the form of apps “installed on”, i.e., scoped to, a physical object. For example, a user may install a tuner application or an instrument learning app “onto” their musical instrument.

In some implementations, AR content associated with a specific object instance may be accessible by multiple users (e.g., members of the same family, etc.) that have been granted permission by a main user/owner. Users having IDs that are known to be associated with the detected object instance may access the AR content. Additionally, or alternatively, a single object instance may be associated with a “differentiated experience” in that different AR content may be provided depending on who is viewing the object in AR.

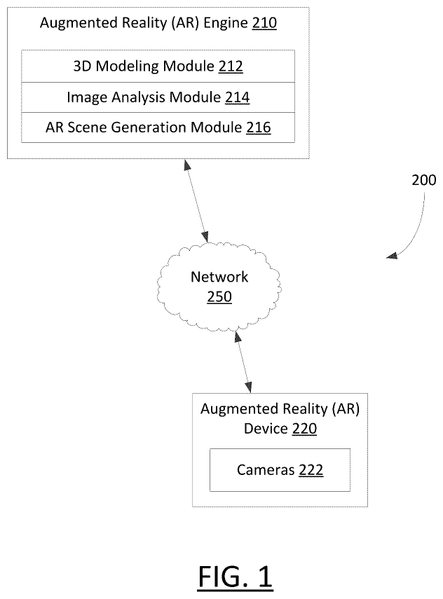

Reference is first made to FIG. 1, which illustrates, in block diagram form, an example system 200 for managing display of AR content on computing devices. As shown in FIG. 1, the system 200 may include an AR engine 210, AR devices 220, and a network 250 connecting one or more of the components of system 200. The AR engine 210 and the AR devices 220 may all communicate via the network 250. In at least some implementations, each of the AR devices 220 may be a computing device. The AR devices 220 may take a variety of forms such as, for example, a mobile communication device such as a smartphone, a tablet computer, a wearable computer (such as smart glasses, augmented reality/mixed reality headset, etc.), a laptop or desktop computer, or a computing device of another type.

The AR device 220 is a computing device that is adapted for providing an augmented reality experience. Specifically, the AR device 220 is configured to combine real-world and computer-generated content, by augmenting a view of a real-world environment with virtual overlay data. The AR device 220 may take various forms such as an optical see-through display, a video see-through display, a handheld device (e.g., a smartphone), a digital projector, or the like. In at least some implementations, an AR device 220 may be suited for being worn or handled by an operator/assembler associated with a manual assembly process. The AR device 220 may, for example, be used for viewing a real-world assembly zone and any virtual content that is overlaid on a view of the assembly zone.

As shown in FIG. 1, the AR device 220 includes certain sensors, such as cameras 222, that can be used to collect sensor data. The sensors of the AR device 220 may include, for example, cameras, LiDAR scanners, microphones, accelerometers, GPS, eye trackers, hand trackers, and the like. The sensors may be configured to capture data for use in generating AR scenes of real-world environments. A user may capture live image or video data depicting their real-world surrounding space using their AR device 220, and the captured image/video data may be overlaid with computer-generated information to generate AR scenes depicting the real-world space. Using their AR device 220, a user can view, edit, manipulate, and otherwise interact with AR scenes featuring objects of interest. In particular, the AR device 220 and associated sensors may be configured to detect, capture, and recognize user input, such as speech, hand gestures, etc., as a user interacts with their real-world environment.

An AR engine 210 is provided in the system 200. The AR engine 210 may be a software-implemented component containing processor-executable instructions that, when executed by one or more processors, cause a computing system to carry out some of the processes and functions described herein. In some implementations, the AR engine 210 may be provided as a stand-alone service. For example, a computing system may engage the AR engine 210 as a service that facilitates providing an augmented reality experience for users of the AR devices 220.

The AR engine 210 supports generation of AR content, such as AR scenes of real-world spaces. The AR engine 210 is communicably connected to one or more AR devices 220. Sensor data from AR devices 220 may be used in generating AR content. For example, AR devices 220 may transmit captured camera and LiDAR scanner data directly to the AR engine 210, or camera/LiDAR scanner data from AR devices 220 may be received at the AR engine 210 via an intermediary computing system. The AR scene data generated by the AR engine 210 may be transmitted, in real-time, to the AR device 220 for viewing thereon. For example, the AR engine 210 may be configured to generate and transmit, to the AR device 220, virtual overlay data associated with AR scenes. That is, the AR engine 210 may provide virtual information which may be displayed, via AR devices 220, as overlay on a view of a real-world environment.

As shown in FIG. 1, the AR engine 210 may include a 3D modeling module 212, an image analysis module 214, and an AR scene generation module 216. The modules may comprise software components that are stored in a memory and executed by a processor to support various functions of the AR engine 210.

The 3D modeling module 212 may perform operations for constructing, editing, storing, and manipulating 3D models of real-world subjects. A real-world subject may be a person, a physical item, or a real-world space. The 3D modeling module 212 may obtain information (e.g., image and video data, measured range/depth data, etc.) about a real-world subject and generate a virtual 3D representation of the subject based on the obtained information. In at least some implementations, the real-world subject information may comprise output data of sensors such as, for example, cameras, LiDAR scanners, microphones, eye trackers, hand trackers, and the like, associated with AR devices 220.

The image analysis module 214 may analyze images that are stored and/or obtained by the AR engine 210. The image analysis module 214 is configured to receive image data (i.e., images, videos, etc.) as input, and outputs various information based on processing the image data. Various algorithms may be included in or implemented by the image analysis module 214—non-limiting examples of such algorithms include: object recognition algorithms, image segmentation algorithms; surface, corner, and/or edge detection algorithms; motion detection algorithms; and the like. In particular, the image analysis module 214 may be configured to detect objects in images (e.g., frames of a video) that are captured in real-time using cameras associated with an AR device and identify various features of the detected objects.

The AR scene generation module 216 is configured to generate AR content. An AR scene comprises a combination of real and virtual (i.e., computer-generated) information. The AR scene generation module 216 may generate virtual content (e.g., animations, text, etc.) for overlaying on a view of a real-world space in AR. The AR scene generation module 216 determines how to align the virtual content with a view of the real-world space. In at least some implementations, virtual content may be anchored to displays of real-world objects in AR scenes. For example, the AR scene generation module 216 may be configured to determine position and orientation, in 3D, of virtual content items relative to real-world objects. The virtual content may then be displayed, on an AR device 220, as digital overlay on a real-world view in accordance with the position/orientation data. For example, the virtual content may be provided to a head-mounted display worn by a user or to a digital projector for projection mapping to real-world surfaces.

In at least some implementations, the AR scene generation module 216 may obtain supplementary data from various data sources in order to generate virtual content. By way of example, the AR scene generation module 216 may be configured to obtain object data for real-world objects that are detected using cameras associated with an AR device 220. The real-world objects that are within a field of view of a camera of an AR device may be identified, for example, based on processing of image data from the camera by the image analysis module 214. Object data associated with the identified real-world objects may be obtained by the AR scene generation module 216, and the virtual content may be generated based, at least in part, on the object data. As will be described in greater detail below, the AR scene generation module 216 may be configured to obtain object data of specific object instances that are identified in image/video data of an AR device.

The AR engine 210 and the AR devices 220 may be in geographically disparate locations. Put differently, the AR devices 220 may be remote from the AR engine 210. As described above, the AR devices 220 and the AR engine 210 may be, or integrated with, computing systems.

The network 250 is a computer network. In some implementations, the network 250 may be an internetwork such as may be formed of one or more interconnected computer networks. For example, the network 250 may be or may include an Ethernet network, an asynchronous transfer mode (ATM) network, a wireless network, or the like.

In some example implementations, the AR engine 210 may be integrated as a component of an e-commerce platform. That is, an e-commerce platform may be configured to implement example implementations of the AR engine 210. In particular, the subject matter of the present application, including example methods for AR-based management of manual assembly processes disclosed herein, may be employed in the specific context of e-commerce. For example, the example methods described in the present application may be implemented to provide a guided manual assembly experience for customers, distributors, or merchants of products that are offered via an e-commerce platform.

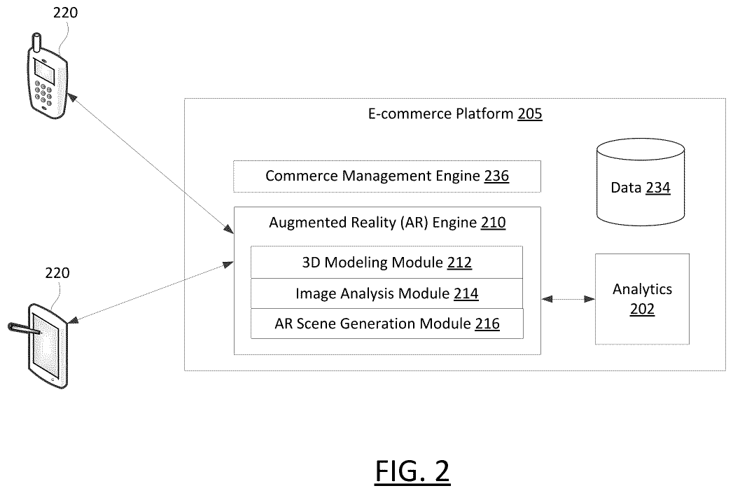

Reference is made to FIG. 2 which illustrates an example implementation of an e-commerce platform 205 that implements an AR engine 210. The AR devices 220 may be communicably connected to the e-commerce platform 205. In at least some implementations, the AR devices 220 may be associated with accounts of the e-commerce platform 205. Specifically, the AR devices 220 may be associated with individuals that have accounts in connection with the e-commerce platform 205. For example, one or more AR devices 220 may be associated with customers having e-commerce accounts or merchants that are associated with one or more online stores on the e-commerce platform 205. The e-commerce platform 205 may store indications of associations between AR devices and customers or merchants of the e-commerce platform, for example, in the data facility 134.

The e-commerce platform 205 includes a commerce management engine 236, an AR engine 210, a data facility 234, and a data store 202 for analytics. The commerce management engine 236 may be configured to handle various operations in connection with e-commerce accounts that are associated with the e-commerce platform 205. For example, the commerce management engine 236 may be configured to retrieve e-commerce account information for various entities (e.g., merchants, customers, etc.) and historical account data, such as transaction events data, browsing history data, and the like, for selected e-commerce accounts.

The functionality described herein may be used in commerce to provide improved customer or buyer experiences. The e-commerce platform 205 may implement the functionality for any of a variety of different applications, examples of which are described herein. Although the AR engine 210 of FIG. 2 is illustrated as a distinct component of the e-commerce platform 205, this is only an example. An engine could also or instead be provided by another component residing within or external to the e-commerce platform 205. In some implementations, one or more applications that are associated with the e-commerce platform 205 may provide an engine that implements the functionality described herein to make it available to customers and/or to merchants. Furthermore, in some implementations, the commerce management engine 236 may provide that engine. However, the location of the AR engine 210 may be implementation specific. In some implementations, the AR engine 210 may be provided at least in part by an e-commerce platform, either as a core function of the e-commerce platform or as an application or service supported by or communicating with the e-commerce platform. Alternatively, the AR engine 210 may be implemented as a stand-alone service to clients such as a customer's AR device. For example, an AR device could store and run an engine locally as a software application.

The AR engine 210 is configured to implement at least some of the functionality described herein. Although the implementations described below may be implemented in association with an e-commerce platform, such as (but not limited to) the e-commerce platform 205, the implementations described below are not limited to e-commerce platforms.

The data facility 234 may store data collected by the e-commerce platform 205 based on the interaction of merchants and customers with the e-commerce platform 205. Merchants may provide data, for example, through their online sales activity. Examples of merchant data include, without limitation, merchant identifying information, product data for products offered for sale, online store settings, geographical regions of sales activity, historical sales data, and inventory locations. Customer data, or data which is based on the interaction of customers and prospective purchasers with the e-commerce platform 205, may also be collected and stored in the data facility 234. Such customer data may be obtained on the basis of inputs received via AR devices associated with the customers and/or prospective purchasers. By way of example, historical transaction events data including details of purchase transaction events by customers on the e-commerce platform 205 may be recorded and such transaction events data may be considered customer data. Such transaction events data may indicate product identifiers, date/time of purchase, final sale price, purchaser information (including geographical region of customer), and payment method details, among others. Other data vis-&-vis the use of e-commerce platform 205 by merchants and customers (or prospective purchasers) may be collected and stored in the data facility 234.

The data facility 234 may include customer preference data for customers of the e-commerce platform 205. For example, the data facility 234 may store account information, order history, browsing history, and the like, for each customer having an account associated with the e-commerce platform 205. The data facility 234 may additionally store, for a plurality of e-commerce accounts, wish list data and cart content data for one or more virtual shopping carts.

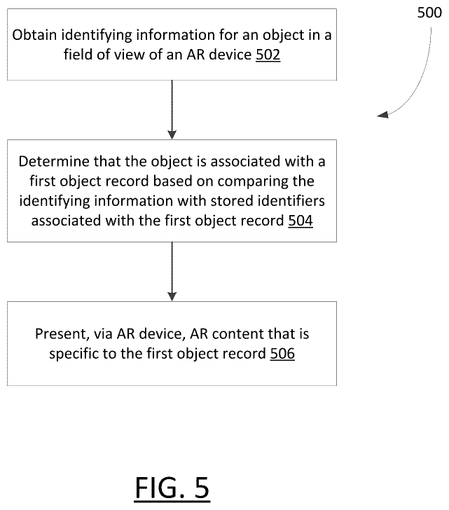

Reference is now made to FIG. 5, which shows, in flowchart form, an example method 500 for selectively displaying AR content associated with real objects. The method 500 may be performed by a computing system that supports generation of virtual overlay content for display via AR devices, such as the AR engine 210 of FIG. 1. As detailed above, an AR engine may be a service that is provided within or external to an e-commerce platform.

AR-enabled computing devices (“AR devices”) may be used to visualize a real-world space. In particular, AR devices provide users with an augmented view of their surroundings. An AR device is typically associated with one or more cameras that are configured to capture image data (e.g., images, videos) depicting an environment of the device. The image data serves as a basis for a real-world view of the surrounding environment, including any real objects in the environment. The real objects that are within a field of view of the cameras may be viewed using the AR device.

An AR engine obtains image data depicting an environment of the AR device. In some implementations, the AR engine may receive image data in real-time from an onboard camera system of the AR device. For example, the image data may comprise video data of a live video that is captured using onboard cameras. The image data may be analyzed by the AR engine (e.g., by an image analysis module) to detect objects that are in a field of view of the cameras/AR device. In particular, real objects in the surrounding environment that are depicted in image data captured by the cameras may be detected by the AR engine.

The AR engine detects an object of interest in a field of view of the AR device. The object of interest may be a real object that falls within a field of view of a camera associated with the AR device, and the object may be detected based on image data captured using the camera. For example, the image data may comprise a video depicting the surroundings of the AR device, and the AR engine may detect the object of interest based on parsing the video using an object detection model. In particular, the AR engine may perform image analysis on frames of the video and the object of interest may be detected in at least one video frame. The object detection model may, for example, be a model that is trained on a large dataset of object (e.g., product) images.

Upon detecting the object of interest, the AR engine obtains identifying information for the detected object, in operation 502. The identifying information represents information that can be used for identifying an object instance (i.e., a specific instance of an object class) of the detected object. In at least some implementations, the identifying information may comprise implicit signals, or information that can be used to indirectly infer the identity of one or more candidates for the detected object. Implicit signals may, for example, represent contextual data associated with the detected object. In particular, the implicit signals may include information describing an environment of the detected object. The implicit signals may include values of environment variables at or after a time of detecting the object of interest.

As a first example of implicit signals, the AR engine may determine the geolocation of a user of the detected object. The user may, in some implementations, be an operator of the AR device. The physical, real-world location of the user may be useful for identifying a specific object instance, for example, by limiting the possible matches to only those object instances that are known to be currently or previously used at that location. In some implementations, LIDAR or other positioning system may be used for determining granular location and position information associated with the user and/or detected object. For example, an Internet Protocol (IP) address or other location-identifying information associated with the AR device may be used to determine the geolocation of the user. The location information for the user may then be used to identify one or more candidate instances of the detected object that are associated with locations matching the user's location. A matching location may, for example, be a same interior building or space as the user, or otherwise a vicinity (e.g., within a threshold distance) of the user's location.

As another example of implicit signals, the AR engine may obtain information describing visual features surrounding the detected object. In some implementations, the AR engine may perform analysis of image data depicting the detected object and its immediate surroundings. The image data may, for example, comprise images (e.g., photos) of the object's surroundings that are obtained by the AR engine. Based on the image analysis, the AR engine may determine visual features, such as a background, nearby objects, etc., that may be used for limiting the possible matches of object instances. For example, the AR engine may identify other objects that are adjacent to or in a vicinity of the object of interest as depicted in the images. In particular, the AR engine may determine, for one or more of the nearby objects, a class and/or specific instance of the object.

Implicit identifying information may be obtained via various sources of environmental data. In at least some implementations, implicit identifying information may be derived based on sensor output of sensors associated with the AR device, such as LIDAR scanner, GPS, indoor positioning system (IPS), image sensors, and the like. The AR engine may be configured to obtain the sensor output from the sensors at or after a time of detecting the object of interest.

Additionally, or alternatively, the identifying information for the detected object may comprise explicit identifying information. In particular, the identifying information may include defined pieces of identifying data that are explicitly associated with the detected object. For example, the identifying information may include at least one of: a barcode, a QR code, an NFC tag, or a serial number. The AR engine may be configured to determine explicit identifying information based on output of one or more sensors (e.g., cameras) or scanners (e.g., NFC scanner). For example, the AR engine may perform image analysis of video data captured by a camera of an AR device to detect an identifier, such as a barcode, associated with the detected object.

In order to identify a specific object instance, the identifying information for the object of interest is compared with object data of known, i.e., previously identified, object instances. The AR engine may have access to data records (“object records”) that include explicit and/or implicit identifying information for various object instances. The object records may, for example, be maintained in a database storing object information for a plurality of known object instances. The stored identifiers associated with object records may include at least one of: geolocation of previous users of an object associated with the first object record; identifiers of objects located in a vicinity of the object associated with the first object record; or an indication of an indoor location associated with the object associated with the first object record.

An object record may be associated with user identifier (ID) information. In particular, an object record may be associated with specific persons that are related to the object instance represented by the object record. An object instance may be associated with one or more persons such as an owner, permitted users, etc. of the object instance. Unique user IDs of the persons associated with the object instance may be stored with the corresponding object record.

In operation 504, the AR engine determines that the object of interest is associated with a first object record based on comparing the identifying information for the object of interest with stored identifiers associated with the first object record. In particular, the AR engine may compare the identifying information with unique identifiers that are stored in object records corresponding to known object instances of the same object class as the object of interest. That is, the comparisons may be performed against only a limited set of object records. If an object record having identifiers that match the identifying information is found, the AR engine determines that the object of interest is associated with said object record. In this way, the AR engine distinguishes the object of interest from at least one other object of the same class based on the identifying information.

In some implementations, the comparisons may result in identification of multiple candidates for the object of interest. That is, the identifying information for the object of interest may “match” more than one object instance. The AR engine may then obtain further identifying information which can be used to reduce the set of candidates to a single object instance. Additionally, or alternatively, the AR engine may iteratively perform the comparisons using different criteria (e.g., modified or alternative thresholds) until identifying a single object instance as the “matching” object.

In response to determining that the object is associated with the first object record, the AR engine presents, via the AR device, AR content that is specific to the first object record, in operation 506. Specifically, the AR engine generates virtual overlay data for displaying via the AR device based on the data of the first object record. In at least some implementations, the AR content may include graphical representations of supplementary information associated with the object instance. The supplementary information may comprise or be derived from the data of the first object record. For example, the AR content may comprise digital overlays (e.g., images, text, etc.) representing object information (e.g., usage data, ownership information, purchase date, expiry date, etc.) for the object instance.

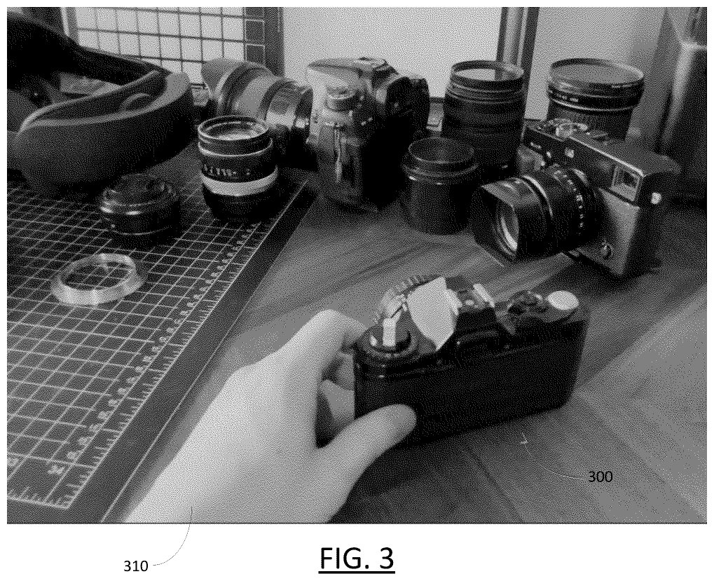

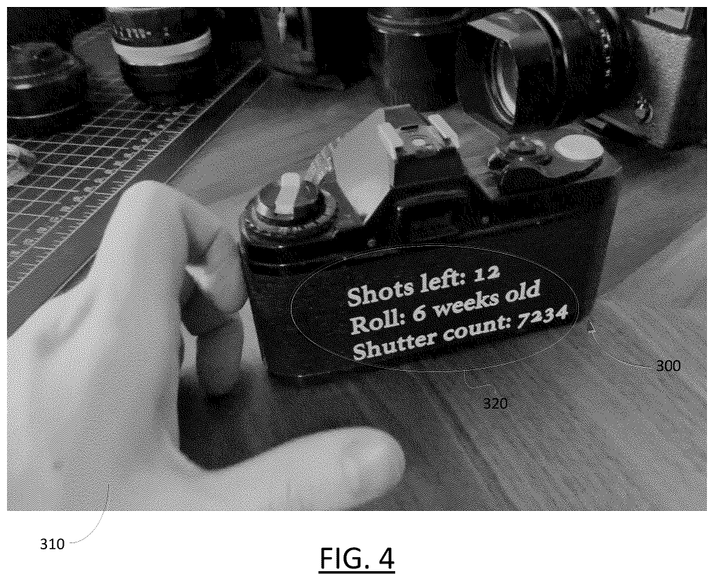

FIG. 3 shows a real-world view of an example analogue camera 300, and FIG. 4 shows an augmented view of the example analogue camera 300 as seen by a user 310 in AR. The AR content 320 that is presented in AR comprises digital overlay of text indicating the number of shots left, age of film roll, and shutter count. The AR content 320 may be generated based on the data of an object record corresponding to the specific object instance of the analogue camera 300 that is detected in accordance with the techniques described above. In at least some implementations, the AR content 320 may be graphically represented as being associated with the object of interest. In the example of FIG. 4, the digital text is shown as overlaid on a view of the analogue camera 300.

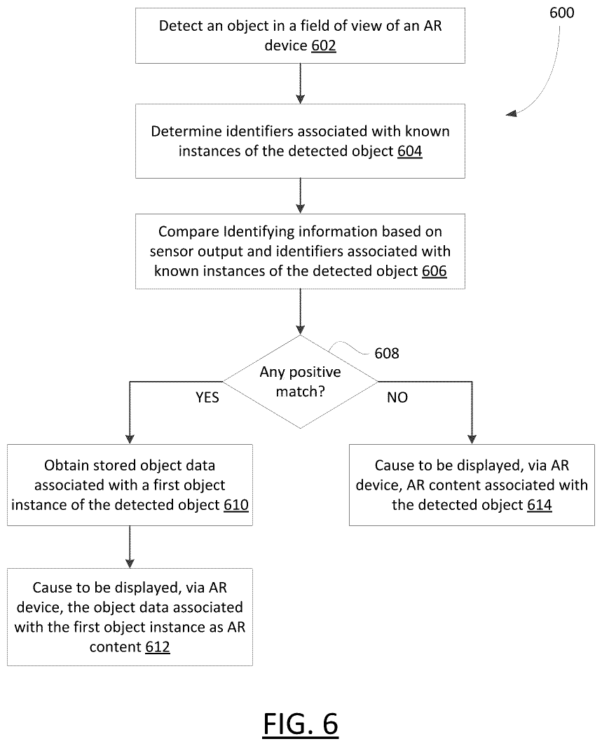

Reference is now made to FIG. 6, which shows, in flowchart form, another example method 600 for selectively displaying AR content associated with real objects. The method 600 may be performed by a computing system that supports generation of virtual overlay content for display via AR devices, such as the AR engine 210 of FIG. 1. As detailed above, an AR engine may be a service that is provided within or external to an e-commerce platform. The operations of method 600 may be performed in addition to, or as alternatives of, one or more operations of method 500.

An AR engine obtains image data (e.g., images, videos) depicting an environment of an AR device. In some implementations, the AR engine may receive image data in real-time from an onboard camera system of the AR device. In operation 602, the AR engine detects an object of interest in a field of view of the AR device. For example, the object of interest may be a real object that falls within a field of view of a camera associated with the AR device. The object of interest may be detected based on analysis of image data acquired using the cameras. The image analysis may be performed using an objection detection model that is trained on one or more image datasets. For example, an image feed from the cameras may be parsed using an object detection model in identifying the object of interest.

The AR engine determines identifiers associated with known instances of the detected object, in operation 604. Specifically, the AR engine obtains unique identifying information for at least one known instance of the detected object. The identifiers may be stored in data records corresponding to the object instances (“object records”). The object records store identifiers that were defined or previously determined for the object instances.

In operation 606, the AR engine compares identifying information for the object of interest with identifiers of one or more known instances of the detected object. The identifying information may be derived based on sensor output of sensors associated with the AR device. Examples of identifying information, both explicit and implicit, were described with reference to FIG. 5. The sensors may include, without limitation, LIDAR scanner, GPS, indoor positioning system (IPS), image sensors, and the like. The AR engine may be configured to obtain the sensor output from the sensors at or after a time of detecting the object of interest.

If the AR engine determines that there is a positive match based on the comparison, the AR engine obtains stored object data associated with the identified object instance (operation 610). That is, the AR engine is configured to obtain instance-specific object data (e.g., usage data, ownership information, purchase date, expiry date, etc.) for the object of interest. The instance-specific data may be stored in an object record (or other data record) associated with the object instance. For example, the instance-specific data may comprise application data for an app that is scoped to the object of interest. A user may install an app (e.g., a tuner or instrument learning app) onto their musical instrument, and the instance-specific data may include saved application data for the app that pertains specifically to the user's instrument.

The AR engine then causes to be displayed, via the AR device, the object data associated with the identified object instance, in operation 612. In particular, virtual overlay content relating to the object data may be provided via the AR device. In at least some implementations, a graphical representation of the association between the virtual overlay content and the object instance may also be presented in an augmented view as seen using the AR device.

If, on the other hand, there is no positive match, the AR engine causes to be displayed, via the AR device, AR content associated with the detected object (operation 614). In particular, the AR content may comprise virtual overlay content relating to generic object data associated with a class of the detected object. For example, the AR content may include a digital label of the object class to which the object of interest belongs.

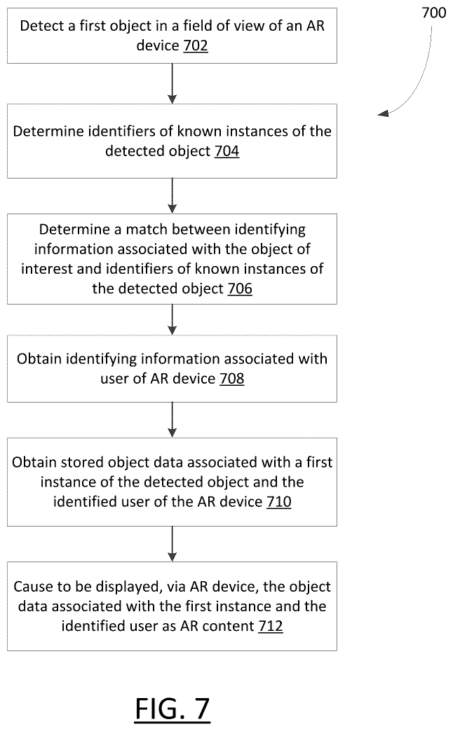

Reference is now made to FIG. 7, which shows, in flowchart form, another example method 700 for selectively displaying AR content associated with real objects. The method 700 may be performed by a computing system that supports generation of virtual overlay content for display via AR devices, such as the AR engine 210 of FIG. 1. As detailed above, an AR engine may be a service that is provided within or external to an e-commerce platform. The operations of method 700 may be performed in addition to, or as alternatives of, one or more of the operations of methods 500 and 600.

In at least some embodiments, AR content associated with a specific object instance may be accessible by multiple users (e.g., members of the same family, etc.) that have been granted permission by a main user/owner. Users having IDs that are known to be associated with the detected object instance may access, i.e., view, the AR content. Additionally, or alternatively, a single object instance may be associated with a “differentiated experience” in that different AR content may be shown depending on who is viewing the object in AR.

In operation 702, an AR engine detects a first object in a field of view of an AR device. The first object may be detected based on analysis of image data from a camera system associated with the AR device. The AR engine determines identifiers of one or more known instances of the detected object (operation 704) and determines a match between identifying information associated with the first object and the identifiers of known instances of the detected object (operation 706). Operations 702 to 706 may be performed in a similar manner as operations 602 to 606, respectively, of method 600.

In operation 708, the AR engine obtains identifying information of a user (e.g., operator) of the AR device. That is, the AR engine determines the identity of the current user of the AR device. The current user may be assumed to be the person who is viewing the first object using the AR device. By identifying the current user, the AR content for presenting via the AR device may be tailored to the user. The identity of the current user may additionally facilitate managing access to access-restricted AR content. Such content may include, for example, protected or private information that is intended to be viewable by a defined set of persons with access privilege.

The identity of the current user may be determined by various techniques. In some implementations, the current user may be required to input authentication credentials such as a passcode, biometric password, and the like. Additionally, or alternatively, the current user may be identified based on context data such as device usage data, application activity data, etc., which may be acquired during active use of the AR device.

Once the current user of the AR device is identified, the AR engine obtains stored object data that is associated with the identified object instance of the detected object and the current user. In particular, the AR engine may be configured to obtain object data for the object instance that is specific to the current user. The user-specific object data may comprise information about the object instance that the current user is permitted to access and/or information that is customized for the current user. For example, the user-specific object data may include stored application data for an app (e.g., an instrument learning app) that is installed on, or scoped to, the detected object (e.g., a musical instrument). The application data may include data that relates specifically to use of the application by the current user such as stored profile data, app usage and progress data, etc., for the user.

As another example, the user-specific object data may include private information relating to the object instance that is accessible to only a defined set of authorized persons. The object data may include protected (e.g., confidential) information that is intended to be kept private from the public. The AR engine verifies that the current user is permitted to access at least some of the access-restricted object data and obtains the subset of object data which the current user is authorized to view using the AR device.

The AR engine then causes to be displayed, via the AR device, AR content comprising the object data associated with the object instance and the current user, in operation 712. In particular, the AR content, such as digital overlays of text, images, etc., may be generated based on the object data that is specific to the current user of the AR device. For example, the AR content may include object data that the current user is permitted to access and/or object data that is specifically tailored to the current user. The AR content may be displayed only during a user session associated with the current user. That is, the AR content may cease to be viewable if the AR engine detects that the current user session has ended (for example, if the current user logs out or a different user begins using the AR device).

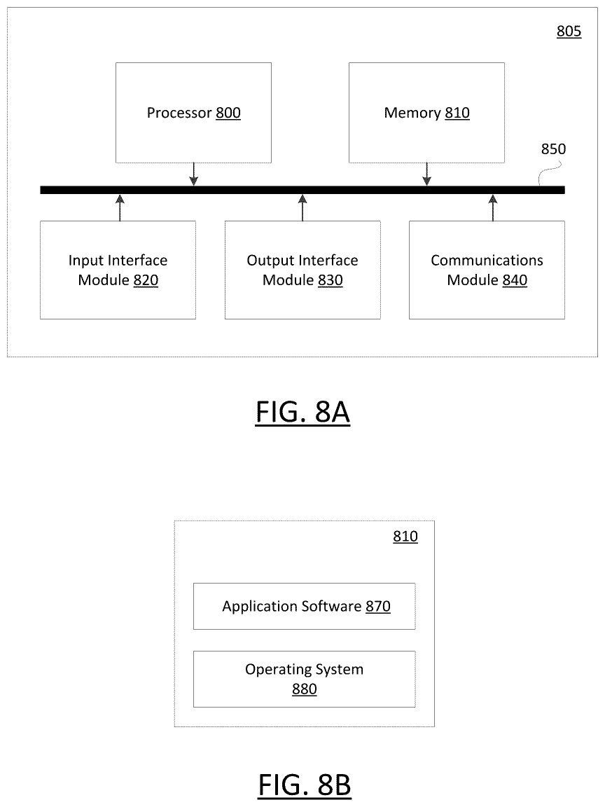

The above-described methods may be implemented by way of a suitably programmed computing device. FIG. 8A is a high-level operation diagram of an example computing device 805. The example computing device 805 includes a variety of modules. For example, as illustrated, the example computing device 805, may include a processor 800, a memory 810, an input interface module 820, an output interface module 830, and a communications module 840. As illustrated, the foregoing example modules of the example computing device 805 are in communication over a bus 850.

The processor 800 is a hardware processor. The processor 800 may, for example, be one or more ARM, Intel x86, PowerPC processors or the like.

The memory 810 allows data to be stored and retrieved. The memory 810 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 805.

The input interface module 820 allows the example computing device 805 to receive input signals. Input signals may, for example, correspond to input received from a user. The input interface module 820 may serve to interconnect the example computing device 805 with one or more input devices. Input signals may be received from input devices by the input interface module 820. Input devices may, for example, include one or more of a touchscreen input, keyboard, trackball or the like. In some implementations, all or a portion of the input interface module 820 may be integrated with an input device. For example, the input interface module 820 may be integrated with one of the aforementioned examples of input devices.

The output interface module 830 allows the example computing device 805 to provide output signals. Some output signals may, for example, allow provision of output to a user. The output interface module 830 may serve to interconnect the example computing device 805 with one or more output devices. Output signals may be sent to output devices by output interface module 830. Output devices may include, for example, a display screen such as, for example, a liquid crystal display (LCD), a touchscreen display. Additionally, or alternatively, output devices may include devices other than screens such as, for example, a speaker, indicator lamps (such as for example, light-emitting diodes (LEDs)), and printers. In some implementations, all or a portion of the output interface module 830 may be integrated with an output device. For example, the output interface module 830 may be integrated with one of the aforementioned example output devices.

The communications module 840 allows the example computing device 805 to communicate with other electronic devices and/or various communications networks. For example, the communications module 840 may allow the example computing device 805 to send or receive communications signals. Communications signals may be sent or received according to one or more protocols or according to one or more standards. For example, the communications module 840 may allow the example computing device 805 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 840 may allow the example computing device 705 to communicate using near-field communication (NFC), via Wi-Fi™, using Bluetooth™ or via some combination of one or more networks or protocols. Contactless payments may be made using NFC. In some implementations, all or a portion of the communications module 840 may be integrated into a component of the example computing device 805. For example, the communications module may be integrated into a communications chipset.

Software comprising instructions is executed by the processor 800 from a computer-readable medium. For example, software may be loaded into random-access memory from persistent storage of memory 810. Additionally, or alternatively, instructions may be executed by the processor 800 directly from read-only memory of memory 810.

FIG. 8B depicts a simplified organization of software components stored in memory 810 of the example computing device 805. As illustrated these software components include an operating system 880 and application software 870.

The operating system 880 is software. The operating system 880 allows the application software 870 to access the processor 800, the memory 810, the input interface module 820, the output interface module 830, and the communications module 840. The operating system 880 may be, for example, Apple™ OS X, Android™, Microsoft™ Windows™, a Linux distribution, or the like.

The application software 870 adapts the example computing device 805, in combination with the operating system 880, to operate as a device performing particular functions.

### Example E-Commerce Platform

Although not required, in some implementations, the methods disclosed herein may be performed on or in association with an e-commerce platform. An example of an e-commerce platform will now be described.

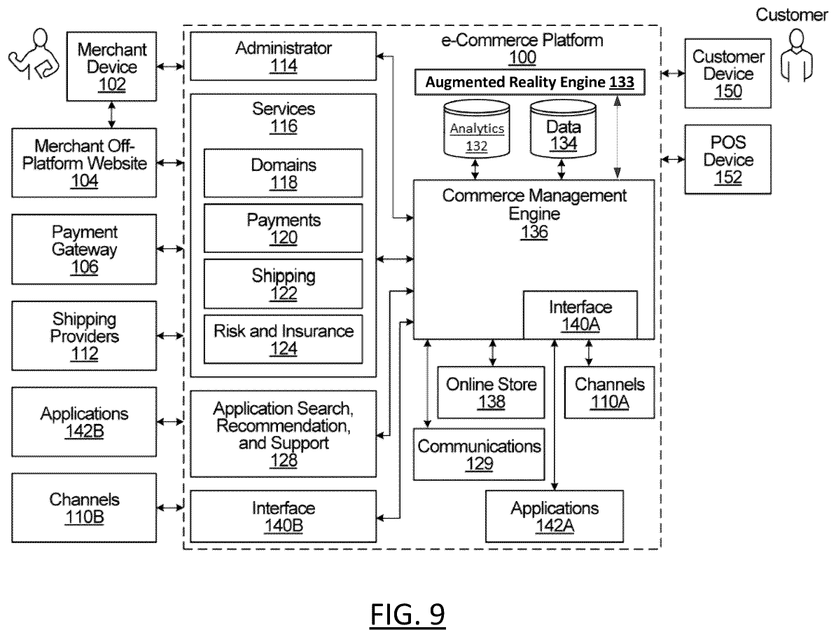

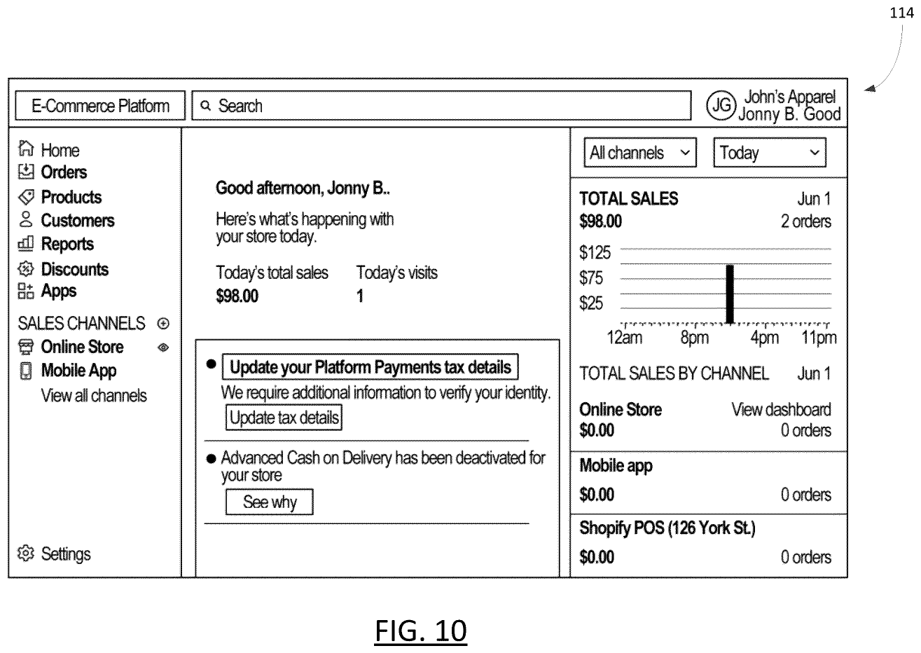

FIG. 9 illustrates an example e-commerce platform 100, according to one implementation. The e-commerce platform 100 may be exemplary of the e-commerce platform 205 described with reference to FIG. 2. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as an AR device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some implementations, additionally or alternatively, be provided by one or more providers/entities.

In the example of FIG. 9, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In implementations, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure, the terms online store and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some implementations, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some implementations, and as described further herein, the e-commerce platform 100 may be implemented through a processing facility. Such a processing facility may include a processor and a memory. The processor may be a hardware processor. The memory may be and/or may include a transitory memory such as for example, random access memory (RAM), and/or a non-transitory memory such as, for example, a non-transitory computer readable medium such as, for example, persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some implementations, elements of the e-commerce platform 100 may be implemented to operate and/or integrate with various other platforms and operating systems.

In some implementations, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some implementations, online store 138 may be or may include service instances that serve content to AR devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally, or alternatively, it may be that themes can, additionally or alternatively, be customized using theme-specific settings such as, for example, settings that may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some implementations, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some implementations, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

FIG. 9 depicts a non-limiting implementation for a home page of an administrator 114. The administrator 114 may be referred to as an administrative console and/or an administrator console. The administrator 114 may show information about daily tasks, a store's recent activity, and the next steps a merchant can take to build their business. In some implementations, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some implementations, the merchant may be able to access the different sections of the administrator 114 by using a sidebar, such as the one shown on FIG. 9. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some implementations, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some implementations, the e-commerce platform 100 may store this data in a data facility 134. Referring again to FIG. 9, in some implementations the e-commerce platform 100 may include a commerce management engine 136 such as may be configured to perform various workflows for task automation or content management related to products, inventory, customers, orders, suppliers, reports, financials, risk and fraud, and the like. In some implementations, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some implementations, may incorporate the administrator 114 and/or the online store 138.

The e-commerce platform 100 may implement an augmented reality engine 133 which may be configured to support at least some of the functions of the AR engine 210 of FIG. 2 described above.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some implementations, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some implementations, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some implementations, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some implementations, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some implementations, update events may be queued and processed asynchronously from a state change that triggered them, which may produce an update event notification that is not distributed in real-time or near-real time.

In some implementations, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some implementations, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an implementation example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example implementation, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some implementations, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some implementations, the commerce management engine 136 may be configured to communicate with various payment gateways and services (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some implementations, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some implementations, the e-commerce platform 100 may enable merchants to keep track of changes to the contract of sales over time, such as implemented through a sales model component (e.g., an append-only date-based ledger that records sale-related events that happened to an item).

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some implementations, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method, comprising:
obtaining identifying information for an object, the object being in a field of view of an AR device, wherein the identifying information comprises implicit signals representing contextual data associated with the object;
determining that the object is associated with a first object record based on comparing the identifying information with stored identifiers associated with the first object record; and
responsive to the determination that the object is associated with the first object record, presenting, via the AR device, AR content that is specific to the first object record.

2. The method of claim 1, wherein the object is of a first class of objects and wherein determining that the object is associated with the first object record comprises distinguishing the object from at least one other object of the same class based on the implicit signals.

3. The method of claim 1, wherein obtaining the identifying information for the object comprises performing object detection based on parsing a video depicting the object using an object detection model.

4. The method of claim 3, wherein obtaining the identifying information for the object comprises performing image analysis on frames of the video.

5. The method of claim 4, wherein the identifying information for the object comprises at least one of a barcode, a QR code, an NFC tag, or a serial number.

6. The method of claim 1, wherein obtaining the identifying information for the object comprises obtaining sensor output of at least one sensor associated with the AR device.

7. The method of claim 6, wherein the at least one sensor comprises at least one of GPS sensor, LIDAR scanner, or image sensors.

8. The method of claim 1, wherein the identifying information for the object comprises at least one of:
geolocation of a user associated with the AR device at a time of detecting the object;
visual features of a vicinity of the object; or
LIDAR data indicating a specific location associated with the object.

9. The method of claim 1, further comprising:
obtaining a user identifier associated with the AR device; and
verifying that a user associated with the user identifier is permitted to access the AR content;
wherein the AR content presented via the AR device is specific to the user associated with the user identifier.

10. The method of claim 1, wherein the stored identifiers associated with the first object record comprise at least one of:
geolocation of previous users of an object associated with the first object record;
identifiers of objects located in a vicinity of the object associated with the first object record; or
an indication of an indoor location associated with the object associated with the first object record.

11. The method of claim 1, wherein the AR content comprises graphical representation of supplementary information associated with the object.

12. A computing system, comprising:
a processor; and
a memory coupled to the processor, the memory storing computer-executable instructions that, when executed by the processor, configure the processor to:
obtain identifying information for an object, the object being in a field of view of an AR device, wherein the identifying information comprises implicit signals representing contextual data associated with the object;
determine that the object is associated with a first object record based on comparing the identifying information with stored identifiers associated with the first object record; and
responsive to the determination that the object is associated with the first object record, present, via the AR device, AR content that is specific to the first object record.

13. The computing system of claim 12, wherein the object is of a first class of objects and wherein determining that the object is associated with the first object record comprises distinguishing the object from at least one other object of the same class based on the implicit signals.

14. The computing system of claim 12, wherein obtaining the identifying information for the object comprises performing object detection based on parsing a video depicting the object using an object detection model.

15. The computing system of claim 14, wherein obtaining the identifying information for the object comprises performing image analysis on frames of the video.

16. The computing system of claim 15, wherein the identifying information for the object comprises at least one of a barcode, a QR code, an NFC tag, or a serial number.

17. The computing system of claim 12, wherein obtaining the identifying information for the object comprises obtaining sensor output of at least one sensor associated with the AR device.

18. The computing system of claim 17, wherein the at least one sensor comprises at least one of GPS sensor, LIDAR scanner, or image sensors.

19. The computing system of claim 12, wherein the identifying information for the object comprises at least one of:
geolocation of a user associated with the AR device at a time of detecting the object;
visual features of a vicinity of the object; or
LIDAR data indicating a specific location associated with the object.

20. A non-transitory processor-readable medium storing processor-executable instructions that, when executed by a processor, are to cause the processor to:
obtain identifying information for an object, the object being in a field of view of an AR device, wherein the identifying information comprises implicit signals representing contextual data associated with the object;
determine that the object is associated with a first object record based on comparing the identifying information with stored identifiers associated with the first object record; and
responsive to the determination that the object is associated with the first object record, present, via the AR device, AR content that is specific to the first object record.
